(19) United States
(12) Patent Application Publication
(10) Pub. No.: US 2010/0188723 A1
(43) Pub. Date: Jul. 29, 2010

(54) OPTICAL MODULATOR WITH BEAM-POINTING CORRECTION

(76) Inventors: Joshua Monroe Cobb, Victor, NY (US); Paul G. Dewa, Newark, NY (US); Justin Kreuzer, Trumball, CT (US)

Correspondence Address: CORNING INCORPORATED, SP-TI-3-1, CORNING, NY, 14831, US

(21) Appl. No.: 12/602,037

(22) PCT Filed: May 29, 2008
(86) PCT No.: PCT/US08/06797

§ 371 Date: Nov. 25, 2009

Related U.S. Application Data
(60) Provisional application No. 60/932,467, filed on May 31, 2007.

(51) Int. Cl. G02F 1/01; G02B 26/08

(52) U.S. Cl. 359/226.2; 359/238

(57) ABSTRACT

An apparatus for providing a modulated pulsed radiation beam (20) has a radiation source (16) for providing a pulsed radiation beam (10) at a constant pulse repetition frequency and a number of beam intensity modulators (18a-18e). A beam-deflecting element (12) in the path of the pulsed radiation beam and rotatable about an axis redirects the pulsed radiation beam cyclically towards each of the plurality of beam intensity modulators in turn. A beam-recombining element rotatable about the axis in synchronization with the beam-deflecting element combines modulated light, from each of the beam intensity modulators in order to form the modulated pulsed radiation beam at the constant pulse repetition frequency. At least one beam-pointing correction apparatus optically conjugates the beam-deflecting element and the beam recombining element at least one rotational position about the axis.

### CROSS-REFERENCE TO RELATED APPLICATIONS

Reference is made to patent application Ser. No. 60/842,306 filed 29 Nov. 2006 and entitled “OPTICAL POWER MODULATION AT HIGH FREQUENCY” by Cobb et al.

### FIELD

This invention generally relates to optical power modulation for high-frequency pulsed light sources and more particularly relates to a method and apparatus for beam-pointing correction in a system that provides modulated pulsed light output.

### BACKGROUND

Pulsed lasers are widely used in applications ranging from surgical devices to lithography systems for forming electronic microcircuits. There are a number of types of devices conventionally used for pulsed laser modulation. These include, for example, devices that deflect a portion of the laser light or cause diffraction, such as various types of acousto-optical modulators (AOM) and electro-optical modulators (EOM). Other types of modulators operate using light polarization state, such as a liquid crystal (LC) modulator. Still other types of pulsed light modulators operate by mechanical action, obstructing some variable portion of the laser beam, actuated by devices such as voice coils, piezoelectric actuators, motors, and servo devices, for example.

Each type of modulator that is conventionally used for pulsed laser modulation has some limitations. For example, mechanical devices operate only within a range of speeds. Some types of devices, such as acousto-optical modulators, are effective only over a range of wavelengths.

One area of particular interest for pulse modulation is in UV lithography. The drive toward continually improved resolution for microcircuit fabrication has stirred interest in using shorter wavelengths, with particular interest in using light in the deep UV region, typically less than about 250 nm. However, modulation of a pulsed laser beam in this wavelength range presents a number of problems that defy conventional solutions. One problem relates to the spectral range, which exceeds the range of modulator devices such as AOM and EOM devices. For example, typical EOM materials such as KD*P (Potassium Dideuterium Phosphate) or KDP (Potassium Dihydrogen Phosphate) exhibit relatively strong absorption at the UV wavelengths, which results in a lower damage threshold of the material over this spectral range. This eliminates these devices as potential modulators for UV lithography applications.

Another problem relates to high pulse rates. UV light at suitable power levels is efficiently provided by excimer lasers, which can operate at pulse rates of 5-6 KHz or higher. This far exceeds the response speeds of mechanical light modulators that would otherwise be operable in the deep UV range. Thus, the combination of very short wavelengths and relatively high pulse frequencies defies conventional light modulation solutions.

Conventional approaches to pulsed laser modulation, constrained with respect to speed and flexibility, in turn limit the capabilities of UV lithography technology. Thus, although higher pulsed laser frequencies have been achieved in the past few years, lithography systems utilizing UV pulsed lasers have been unable to harness the additional potential this offers for enhanced exposure accuracy and processing speed.

One method that has been proposed in patent application Ser. No. 60/842,306 filed 29 Nov. 2006 and entitled “OPTICAL POWER MODULATION AT HIGH FREQUENCY” by Cobb et al. provides an apparatus with a beam deflector that cyclically redirects one or more individual light pulses to each of a number of separate light intensity modulators, then provides a beam recombiner for combining the modulated pulses onto a single output path. While this method allows pulse-to-pulse modulation, problems resulting from slight mechanical misalignment, velocity irregularity, or pulse timing jitter can result in beam pointing artifacts at the output of this system. There is thus a need for a beam-pointing correction apparatus for this and other types of devices that may redirect and recombine light beams.

### SUMMARY

It is an object of the present invention to advance the art of laser light modulation. With this object in mind, the present invention provides an apparatus for providing a modulated pulsed radiation beam, comprising:
a) a radiation source for providing a pulsed radiation beam at a constant pulse repetition frequency;
b) a plurality of beam intensity modulators;
c) a beam-deflecting element in the path of the pulsed radiation beam and rotatable about an axis to redirect the pulsed radiation beam cyclically towards each of the plurality of beam intensity modulators in turn;
d) a beam recombining element rotatable about the axis in synchronization with the beam-deflecting element and disposed to combine modulated light from each of the plurality of beam intensity modulators in order to form the modulated pulsed radiation beam at the constant pulse repetition frequency; and
e) at least one beam-pointing correction apparatus that optically conjugates the beam-deflecting element and the beam recombining element at least one rotational position about the axis.

It is a feature of the present invention that it provides passive optical compensation for timing jitter or alignment error in a pulsed light modulator.

It is an advantage of the present invention that it helps to minimize or eliminate beam-pointing artifacts.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a timing diagram showing the input and modulated output pulse sequence using the present invention.

FIG. 2 is a schematic and timing diagram showing the synchronization of pulse distribution and modulation according to the present invention.

FIGS. 3A and 3B are perspective views showing an optical modulator using coupled rotating monogons as beam deflector and recombiner in one embodiment.

FIG. 4A is a side view showing a portion of the embodiment of FIGS. 3A and 3B.

FIG. 4B is a side view of an alternate embodiment that uses a rotating wedged reflector.

FIG. 5 is a side view of a rotating double-monogon embodiment showing a beam-pointing error condition.

FIG. 6 is a side view of a rotating double-monogon embodiment provided with a beam-pointing correction apparatus according to one embodiment of the present invention.

FIG. 7 is a schematic view of the beam-pointing correction components in an embodiment using lenses.

FIGS. 8A, 8B, 8C, and 8D show passive compensation provided for a beam positioning error in one modulation channel, using the apparatus and methods of the present invention.

FIG. 9 shows a side view of a rotating reflective wedge in an embodiment using reflective curved surfaces for beam positioning compensation.

FIG. 10 is a perspective view showing an embodiment using arrays of curved reflective surfaces for beam positioning compensation, one pair of curved reflective surfaces in each modulation channel.

FIG. 11 is a side view that shows the use of a single pair of curved reflective surfaces for beam-pointing error compensation.

FIG. 12 is a perspective view of a beam generation apparatus using a single pair of curved reflective surfaces for beam-pointing error compensation.

### DETAILED DESCRIPTION

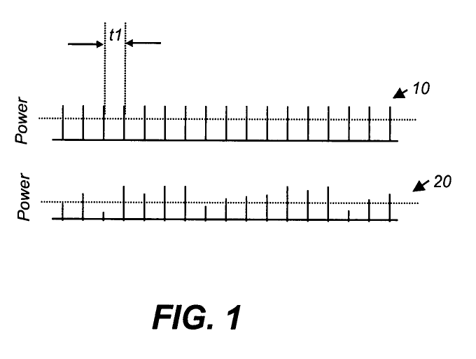

The timing chart of FIG. 1 shows the overall goal of the present invention: namely, to provide a modulated, high frequency pulsed radiation beam 20 that is generated from a pulsed radiation beam 10 having a relatively constant power output. The apparatus and method of the present invention are adaptable to a range of periods t1, particularly including periods t1 that are shorter than the response times of individual modulating components themselves. In embodiments described subsequently, for example, an array of modulator components, where each individual component has a maximum response time of only about 1 KHz, can be used to modulate a pulsed laser beam that has a pulsed repetition frequency of 5 KHz (with a period t1 of 0.2 msec). As FIG. 1 shows, each individual pulse of a high-frequency modulated pulsed radiation beam 20 can be modulated, allowing a highly precise delivery of output power, pulse by pulse. Schematic diagrams in subsequent figures show the path of pulsed radiation beam 10 input and show how modulated pulsed radiation beam 20 is formed in various embodiments.

Figures shown and described herein are provided in order to illustrate key principles of operation and component relationships along their respective optical paths according to the present invention and are not drawn with intent to show actual size or scale. Some exaggeration may be necessary in order to emphasize basic structural relationships or principles of operation. Some conventional components that would be needed for implementation of the described embodiments, such as rotational actuators or optical mounts, for example, are not shown in the drawings in order to simplify description of the invention itself. In the drawings and text that follow, like components are designated with like reference numerals, and similar descriptions concerning components and arrangement or interaction of components already described are omitted.

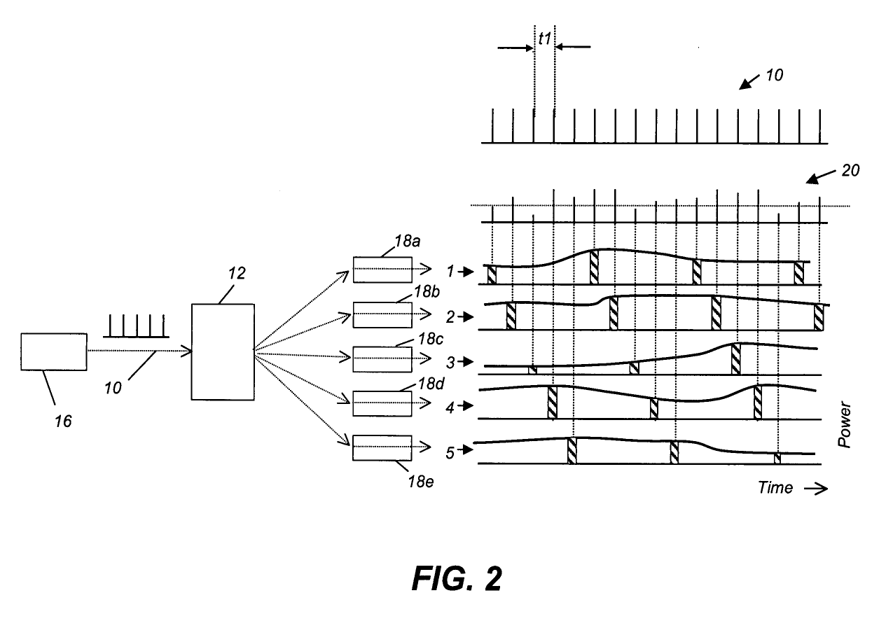

The schematic of FIG. 2 shows generally how pulsed radiation beam 10 from a laser 16 can be modulated at high rates of speed using a beam deflector 12 and two or more slower light modulators. By way of illustration, the example of FIG. 2 shows five modulators 18a, 18b, 18c, 18d, and 18e, although any number of modulators could be used. For this example, pulsed radiation beam 10 is provided at a frequency of 5 KHz, so that period t1 is 0.2 msec. Example modulation level graphs for modulators 1 through 5 (corresponding to modulators 18a through 18e) are also shown to the right of each modulator. Thus, for example, modulator 18a sets the level of the first pulse of modulated pulsed radiation beam 20, modulator 18b sets the level of the second pulse, modulator 18c sets the level of the third pulse, and so on. Note, for example, that it takes some time for modulator 18a to transition between the attenuation level needed for providing the first pulse and the level needed to provide the sixth pulse. Relative to the 0.2 msec period t1 of the pulsed laser output, modulators 18a through 18e respond slowly, with a typical response time that can be in the 1 KHz frequency range, that is, with a period of 1.0 msec. Thus, for example, a single modulator 18a clearly operates too slowly to be able to controllably modulate each individual pulse in a 5 KHz sequence of pulses. However, as the schematic of FIG. 2 shows, beam deflector 12 is used as a beam-deflecting element to redirect pulses to two or more of these slower modulators in order to provide pulse-by-pulse modulation of a pulsed laser beam that has a period t1 shorter than modulator response time. Modulated pulses are then recombined onto a single path, as described subsequently.

It is instructive to note that beam deflector 12 used in this multiplexing scheme may direct a single pulse or two or more successive pulses to one of modulators 18a, 18b, 18c, 18d, or 18e at a time. For precise control of output power, it is preferable to direct an integer number (that is, a whole or counting number: 0, 1, 2, 3, etc.) of sequential pulses to any single modulator channel with precision timing. The embodiment shown in FIG. 2 has each modulator 18a, 18b, 18c, 18d, or 18e modulate a single pulse at a time, that is, at a given attenuation level. However, two or more sequential pulses could be sent to each modulator, in turn, for attenuation at the same level, for example.

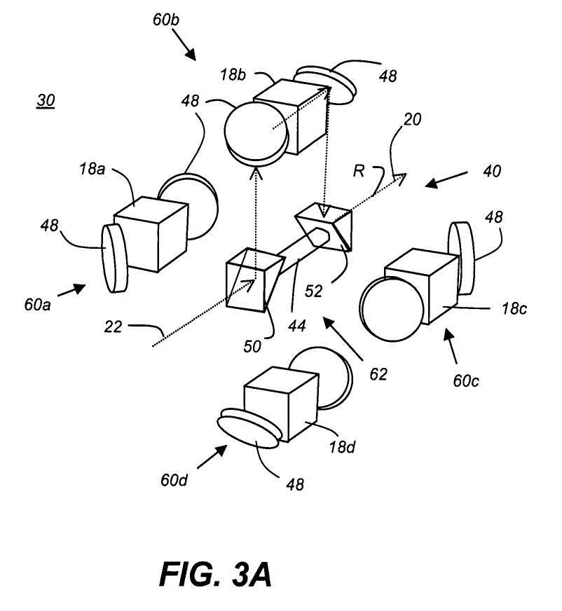

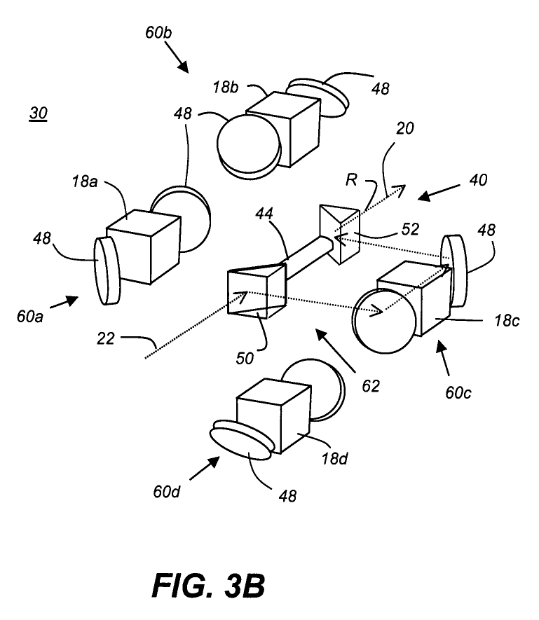

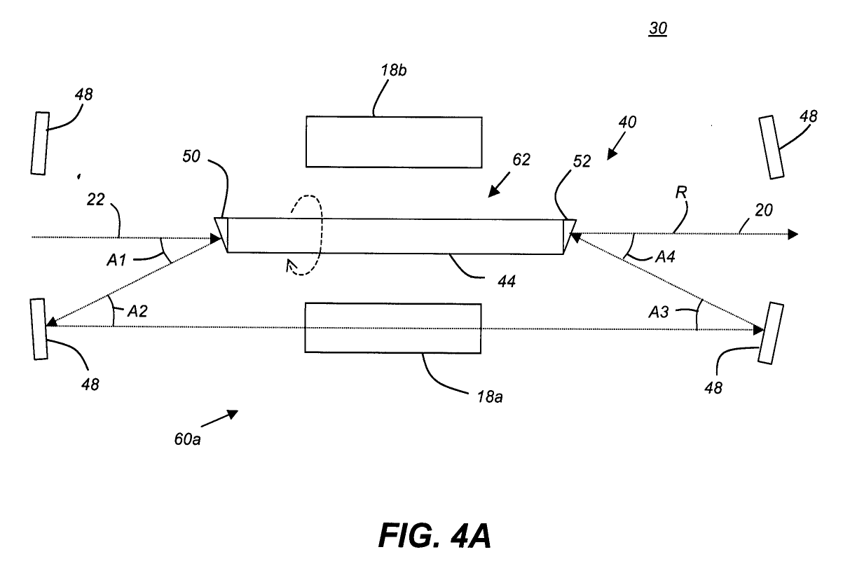

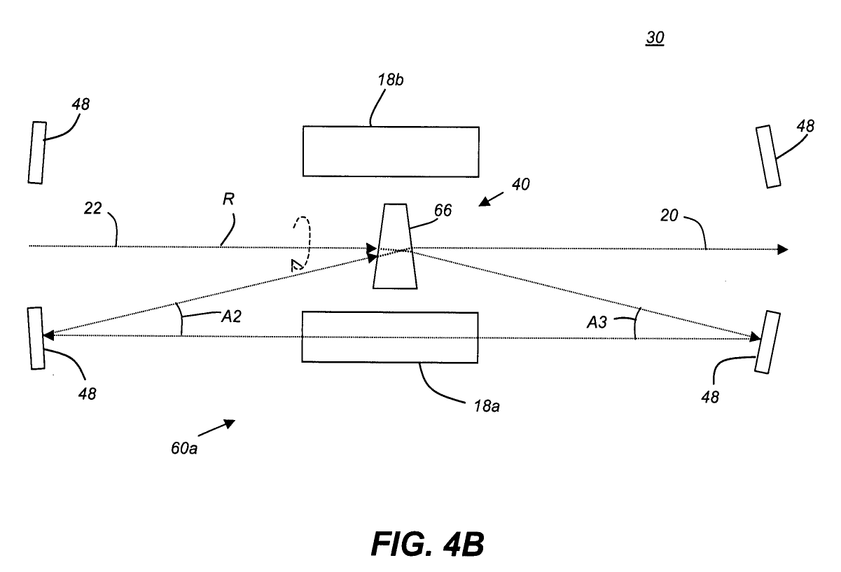

Referring to FIGS. 3A and 3B, the functions of beam deflection, pulse modulation, and beam recombination can be performed using a number of possible combinations of components. A beam generation apparatus 30 in the embodiment shown in perspective view in FIGS. 3A and 3B employs a rotating double monogon 62. Rotating double monogon 62, shown also in the side view of FIG. 4A, consists of two monogons 50, 52 on opposite ends of a rotatable shaft 44. In operation, rotating double monogon 62 performs two essential functions: (i) a beam-deflecting element, as described with respect to beam deflector 12 in FIG. 2; and (ii) as a beam-recombining element, beam combiner 40, for recombining the modulated output light beams by deflecting the modulated output beams onto a single optical path to form a modulated pulsed radiation beam 20. Beam generation apparatus 30 shown in FIGS. 3A and 3B has four modulation channels 60a, 60b, 60c, and 60d. Each modulation channel 60a, 60b, 60c, and 60d has a corresponding modulator 18a, 18b, 18c, 18d along with a pair of supporting turning mirrors 48 for directing unmodulated light in and modulated light out.

FIG. 3A traces the path of light to modulation channel 60b. First monogon 50 rotates into position for modulation channel 60b and directs one or more pulses to modulator 18b, through turning mirror 48. The modulated output from modulation channel 60b is then directed, through a second turning mirror 48, to second rotating monogon 52 that, acting as beam combiner 40, directs the modulated light to the output as part of modulated pulsed radiation beam 20.

This sequence continues as shaft 44 rotates and directs light to modulation channel 60c, as shown in FIG. 3B. Here, light is modulated at modulator 18c and similarly redirected to second rotating monogon 52 acting as beam combiner 40. In similar fashion, as shaft 44 rotates, pulsed light is cyclically directed to and from each modulation channel 60a, 60b, 60c, and 60d in turn.

FIG. 4A illustrates the basic arrangement of FIGS. 3A and 3B in side view. For clarity, only two modulators 18a and 18b are shown in this particular view; additional modulators could be distributed at suitable angular positions about axis of rotation R, as is shown in the example of FIGS. 3A and 3B. Double monogon 62 in beam generation apparatus 30 provides both beam-deflecting and beam recombining elements, with monogon 50 serving as a beam deflector component and monogon 52 as a beam recombiner component. In the particular example of FIG. 4A, reduced incidence angles improve the handling of polarized light. Because reflection at higher incidence angles can adversely affect polarization, it is advantageous to reflect polarized light at acute angles, preferably at acute angles of less than 45 degrees. With the angular arrangement of double monogon 62 and mirrors 48 in FIG. 4A, incidence and reflection angles A1, A2, A3, and A4 are reduced, minimizing the effects of reflection upon polarization state.

FIG. 4B shows yet another arrangement in which a single refractive component provides both beam deflection, as a beam-deflecting element, and beam recombination, as a beam-recombining element. The side view of FIG. 4B shows an embodiment of beam generation apparatus 30 that uses a refractive rotating prism 66 as its rotating beam deflector and beam recombiner. Refractive rotating prism 66 rotates about axis R (which is in the plane of the page). At the rotational position that is shown in FIG. 4B, refractive rotating prism 66 redirects one or more pulses of incident pulsed radiation beam 22 to mirror 48 at an acute incidence and reflection angle A3. Mirror 48 reflects the light toward modulator 18a. The modulated light pulse that is output from modulator 18a is then reflected back toward refractive rotating prism 66 from second mirror 48. Incidence and reflection angles A2 and A3 are reduced with this embodiment. Again, as with FIG. 4A, only two modulators 18a and 18b are shown; additional modulators could be distributed at suitable angular positions about axis of rotation R.

While the embodiments shown in FIGS. 3A, 3B, 4A, and 4B work well, it can be appreciated that there is some sensitivity to pulse timing jitter, rotational irregularities, and overall mechanical tolerance. In the ideal case, the recombined pulses that form modulated pulsed radiation beam 20 would be perfectly aligned along the output optical axis, co-linear with axis of rotation R in FIGS. 3A-4B. In practice, however, any slight timing, rotational, or mechanical alignment error can result in beam pointing artifacts that reduce the effectiveness and aiming accuracy of modulated pulsed radiation beam 20.

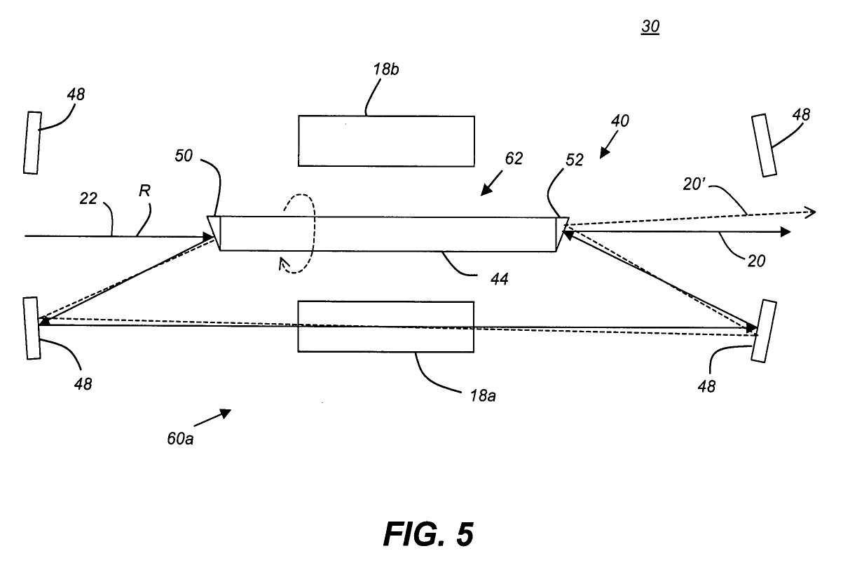

The side view of FIG. 5 shows how a beam-pointing artifact can occur. In this figure, the solid lines indicate the intended light path for the pulsed radiation beam. Dashed lines indicate an actual light path that results in a beam-pointing artifact. Signal jitter, rotational jitter, or slight mechanical misalignment causes a slight angular error when pulsed radiation beam 22 reaches the reflective surface of first rotating monogon 50. This beam is deflected toward first turning mirror 48 and is directed through light modulator 18a at an angle that is slightly off-center with respect to the intended light path. Modulated light from modulator 18a is then reflected from second turning mirror 48, again with the angular error component. Rotating monogon 52, acting as a beam-recombining element, then deflects this light toward the output. With the accumulated angular error, however, this redirected light is not at the same angle as the intended modulated pulsed radiation beam 20 but is slightly divergent, as modulated pulsed radiation beam 20′. In some cases, the angular error may be enough to prevent the output pulse from being properly handled by other components in the optical system or may be pronounced enough to direct the output beam to an incorrect target or location on a surface.

A conventional approach to preventing beam-pointing artifacts would be to minimize or eliminate signal jitter, rotational jitter, or any mechanical misalignment of beam-deflecting and beam-recombining elements. However, it can be appreciated that high costs in component fabrication, assembly, and testing needed to achieve this result would be prohibitive. Moreover, even if such error sources could be eliminated, there is inherently a more subtle timing complication related to pulse width. Even though the laser pulse is very narrow, with typical pulse widths of no more than about 50-100 nsec or less for some types of excimer lasers, there is some “divergence stretch” effect that occurs simply because the leading and trailing edges of a pulse are separated in time and rotation of monogons or other beam deflector 12 components is continuous, taking place during this time. That is, with respect to the component arrangement of FIG. 5, the leading edge of a laser pulse is reflected to first turning mirror 48 when monogon 50 is at a first rotational angle. The trailing edge of the same laser pulse is reflected when monogon 50 is at a second rotational angle, just slightly rotated from the first rotational angle. As a result, a slight divergence can be noted due to this effect, just incrementally widening the output modulated pulsed radiation beam 20 relative to the input pulsed radiation beam 22.

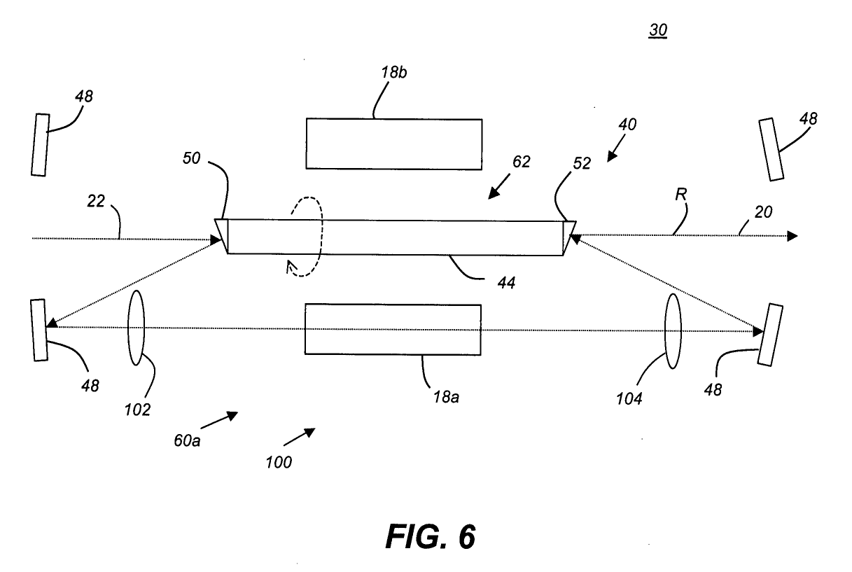

The present invention addresses the problem of beam-pointing artifacts, including divergence stretch, in a passive manner, using an optical system that conjugates the light-redirecting surface of a rotating beam-deflecting element with the corresponding light-redirecting surface of a rotating beam-recombining element. Referring to the side view of FIG. 6, there is shown one embodiment of beam generation apparatus 30 that uses a beam pointing correction apparatus 100 according to the present invention. Here, beam-pointing correction apparatus 100 is within modulation channel 60a and directs light to and from modulator 18a. With this type of arrangement, each modulation channel would have its own beam-pointing correction apparatus 100.

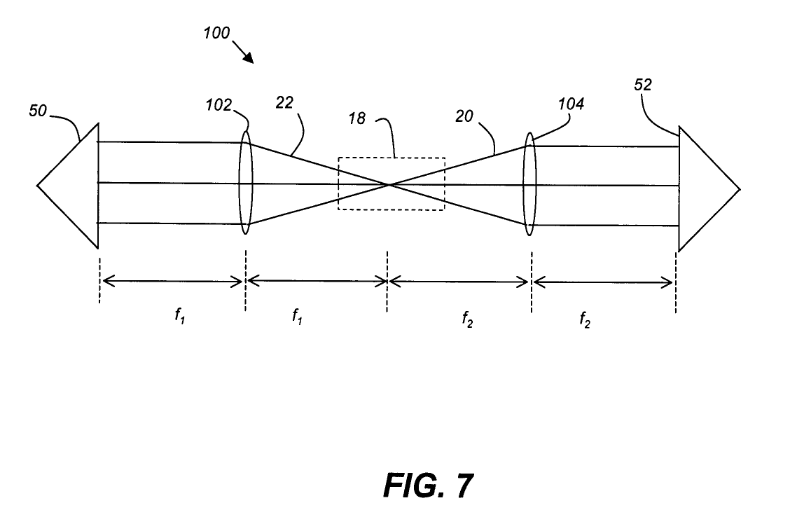

The schematic view of FIG. 7 shows the arrangement of beam-pointing correction apparatus 100 components as used in FIG. 6, optically unfolded. As a system, beam-pointing correction apparatus 100, consisting of lenses 102 and 104, is afocal, resembling the optical configuration of a 1× telescope. The light-redirecting surface of monogon 50 is at the front focal plane of lens 102. This light-redirecting surface is optically conjugate with the light-redirecting surface of monogon 52 at the back focal plane of lens 104. The relative position of a modulator 18 centered between lenses 102 and 104 is shown in phantom, for reference, although any appropriate position between lenses 102 and 104 would be suitable. The light entering modulator 18 is the unmodulated pulsed radiation beam 22; the light exiting modulator 18 is modulated pulsed radiation beam 20.

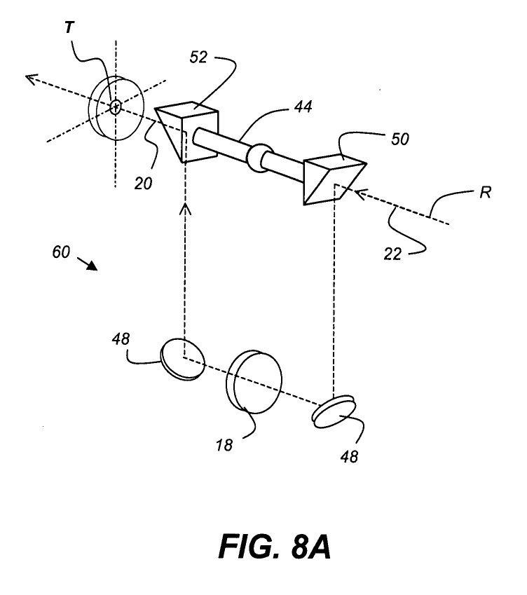

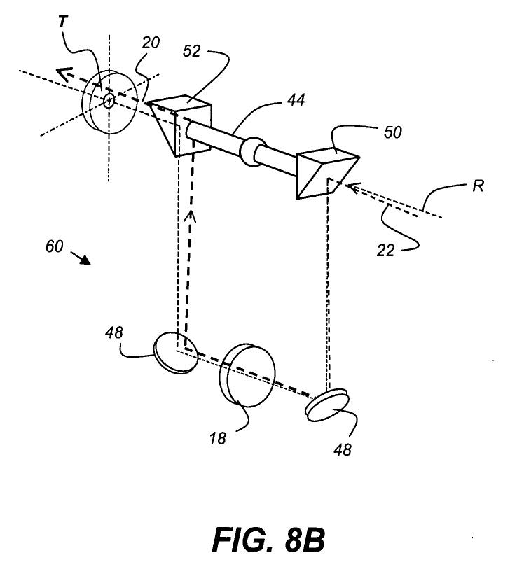

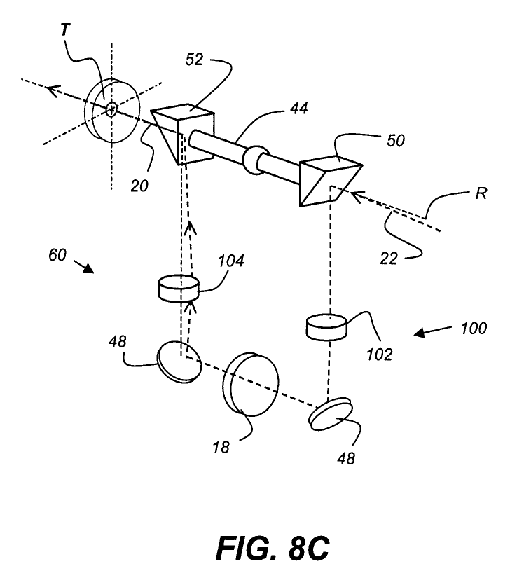

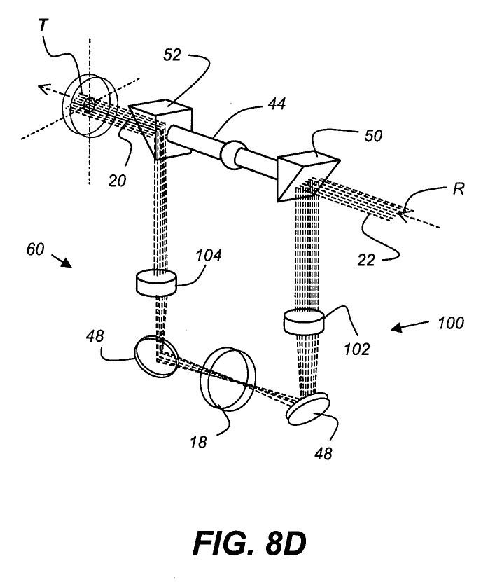

Beam-pointing correction apparatus 100 operates by optically conjugating these two light redirecting surfaces at 1× magnification and maintaining collimation of input and output beams. The sequence shown in FIG. 8A through 8D shows how this arrangement handles off-angle light that would otherwise cause beam-pointing artifacts. FIG. 8A shows, for a single modulation channel 60, an ideal alignment of the system without a beam-pointing correction scheme. In this case, monogon mirrors 50 and 52, acting as beam-deflecting and beam-recombining elements, are perfectly aligned when the laser pulse strikes the first monogon 50. The resultant modulated output pulse of modulated pulsed radiation beam 20 is then directed to a target T, represented with crosshairs, at the correct location. By comparison, FIG. 8B shows what happens when there is misalignment between the monogon mirrors 50, 52 and the input laser pulse. In this case, first monogon mirror 50 directs the pulse at an angle that diverges slightly from the ideal optical path of FIG. 8A. After modulation at modulator 18, second monogon mirror 52 again directs the pulse at a divergent angle, so that modulated pulsed radiation beam 20 is off-target, as indicated by a dashed line. FIG. 8C shows how beam pointing correction apparatus 100 works. By optically conjugating or imaging the reflective surface of first monogon 50 with the reflective surface of second monogon 52, here through lenses 102 and 104, beam pointing correction apparatus 100 corrects the slight angular error in beam direction. As a result, modulated pulsed radiation beam 20 remains on-target.

Collimation is also preserved by the 1× telescope arrangement, with internal focus, of beam pointing correction apparatus 100 in this embodiment. As FIG. 8D shows, collimated light is input in pulsed radiation beam 22, is modulated, and is then output as collimated light in modulated pulsed radiation beam 20.

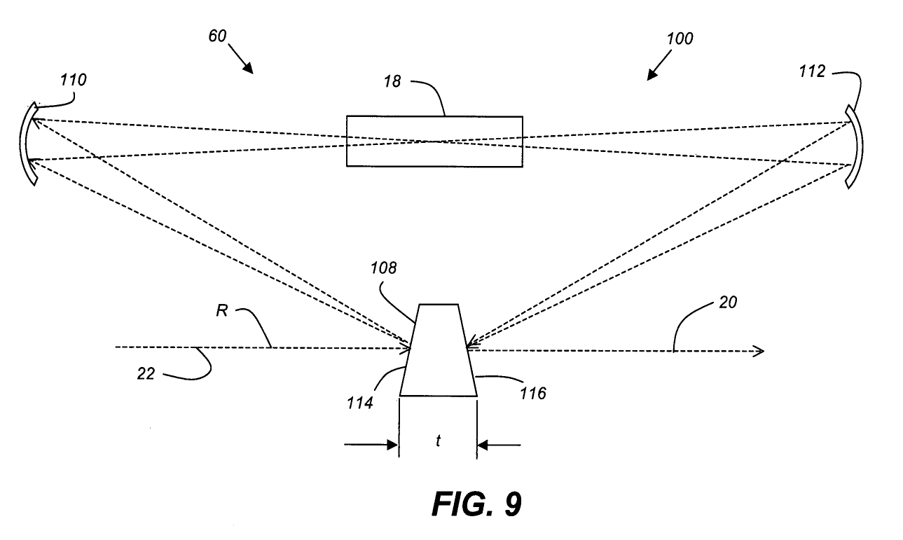

Another embodiment of beam pointing correction apparatus 100 is shown in FIG. 9, using curved reflective optical components as an alternative to the lenses 102 and 104 that are used in the refractive embodiment of FIG. 6. A modulation channel 60 has modulator 18 and beam-pointing correction apparatus 100 that uses first and second spherical relay mirrors 110 and 112. A rotating reflective wedge 108, or equivalent component, has reflective surfaces 114 and 116 that serve as beam-deflecting and beam-recombining elements, respectively. The distance between reflective surfaces 114 and 116, shown here as thickness t, is determined by the focal length of spherical relay mirrors 110 and 112 and the fold angle of the mirrors. First reflective surface 114 is one focal length from first spherical relay mirror 110. Similarly, second reflective surface 116 is one focal length from second spherical relay mirror 112. Modulator 18 is shown here substantially centered between first and second spherical relay mirrors 110 and 112, that is, at a distance of one focal length from each of spherical relay mirrors 110 and 112. However, it can be advantageous to position modulator 18 at some other point along the optical path between relay mirrors 110 and 112.

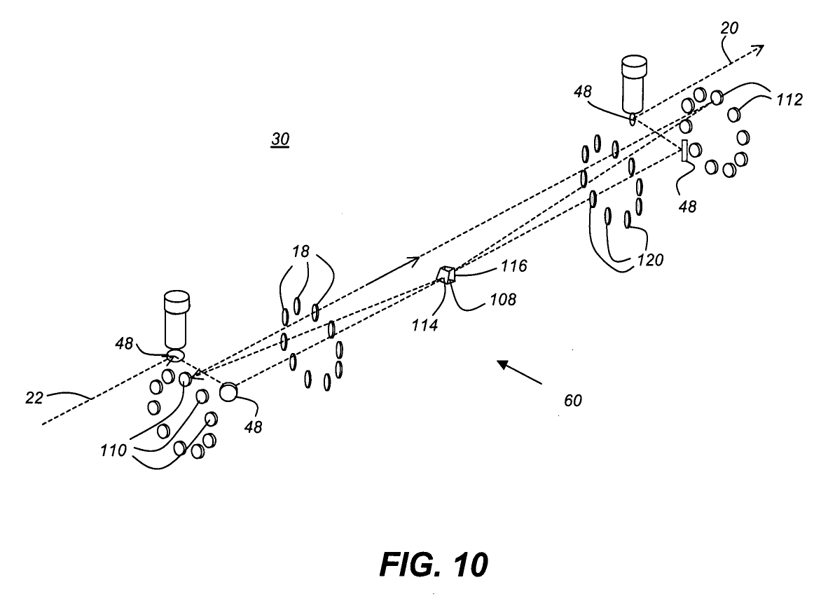

The perspective view of FIG. 10 shows an embodiment of beam generation apparatus 30 that provides a reflective beam-pointing correction apparatus 100 in each of ten modulation channels 60. The light path through one of the modulation channels 60 is shown in dashed lines. In this arrangement, modulator 18 in each modulation channel 60, shown here as a galvanometer-actuated component, is placed nearest first spherical relay mirror 110. Turning mirrors 48 direct pulsed radiation beam 22 into, and modulated pulsed radiation beam 20 out from, beam generation apparatus 30. Reflective wedge 108 rotates, directing pulsed radiation beam 22 to each of relay mirrors 110 in succession and, from there, through each corresponding modulator 18. In this embodiment, compensator plates 120 are provided for the output light from modulator 18, modulated pulsed radiation beam 20. Beam 20 is directed back toward reflective wedge 108 by the appropriate curved relay mirror 112. From here, the light goes to turning mirrors 48 for redirection as output light.

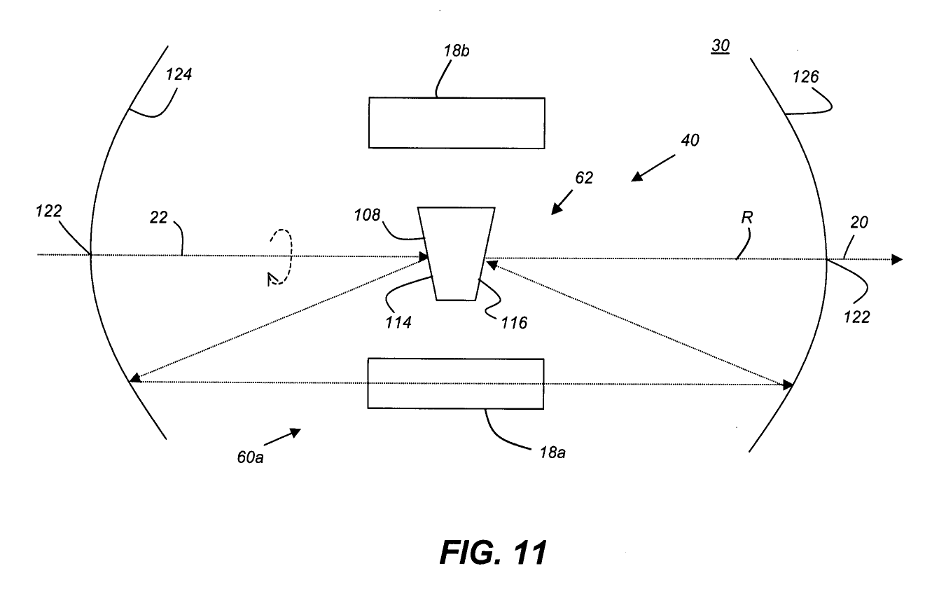

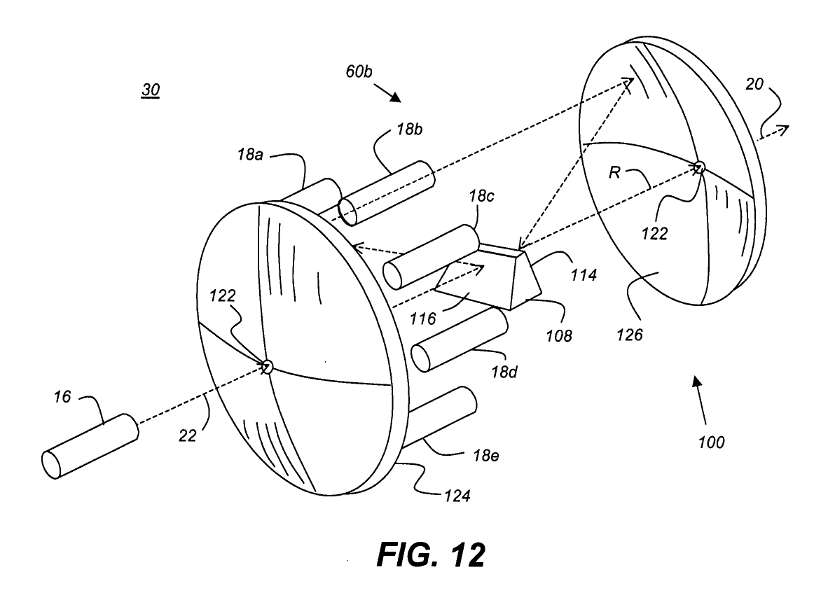

An alternative to using a pair of relay mirrors 110 and 112 in each modulation channel 60 is shown in side and perspective views, respectively, of FIGS. 11 and 12. Here, the same two curved reflective surfaces 124 and 126 are used as the relay mirrors for each modulation channel 60. In one embodiment, curved reflective surfaces 124 and 126 are spherical mirror surfaces, where the center of curvature of curved reflective surface 124 is at a vertex of curved reflective surface 126. Similarly, the center of curvature of curved reflective surface 126 is at a vertex of curved reflective surface 124. Each reflective surface 124, 126 has an aperture 122 that allows the laser beam to enter and exit beam generation apparatus 30; alternately, turning mirrors could be used to direct light into or out from this embodiment of beam generation apparatus 30. In FIG. 12, the light path through modulation channel 60b with modulator 18b is shown. Reflective wedge 108 rotates about axis R as noted earlier, directing light cyclically to each of the modulation channels in succession. Modulation channel components are distributed about axis R at substantially equal angular increments.

As the embodiments presented in FIGS. 6 through 12 show, there are numerous possible arrangements for providing the beam-pointing compensation function. The invention can be used with various laser power levels, given suitably designed beam-shaping optics, beam deflection devices, and modulation devices. In one embodiment, for example, the source pulses are delivered from an excimer laser at about 10 mJ (milli-Joules) per pulse. Pulse widths for pulsed laser sources are typically very small relative to the time period (t1 in FIG. 1) with typical pulse widths generally in the 50 ns to 100 ns range.

As can be seen from the example embodiments shown herein, the apparatus and method of the present invention allow the use of multiple, relatively slow beam intensity modulators, arranged in an array for performing pulse-by-pulse modulation of a pulsed radiation beam. This enables the relative intensity of each individual pulse to be controlled, which has decided advantages for applications such as UV lithography.

In addition to pulse-to-pulse modulation, another advantage afforded by the apparatus and method of the present invention relates to improved power dissipation. By directing a small number of laser pulses to each of a number of modulation channels in a cyclic manner, the present invention can be used to help extend the lifetime of modulation components and their support optics.

Any of a number of types of beam intensity modulators could be employed as modulator 18 in an apparatus of the present invention, including AOM, EOM, or LC devices, piezoelectric- or servo-actuated apertures, shutter(s) including rotating shutters or shutters actuated otherwise, or slits actuated by piezoelectric actuators or servo devices or voice coils, galvanometer-actuated devices, or other devices. For example, electro-optic modulators can include Pockels cell devices, variable spaced Fabry-Perot etalons, partially transmitting meshes and perforated plates, partially transmitting or partially reflecting optical coatings or surfaces, bulk absorbing optical materials, and mechanical mechanisms such as moving blades or shutters. Optical coatings, such as dielectric films, can be used to obtain variable transmission by tilting attenuator elements as well as by interchanging fixed elements or translating elements that have a transmission gradient across the pulsed light path. Either step-wise attenuation control or continuous variable control could be used. Discrete intervals of attenuation can be linear, logarithmic, or have other input-to-output characterization.

While the apparatus of the present invention has been chiefly described for embodiments in which beam deflector 12 and beam combiner 40 are reflective, alternate ways of deflecting light can be employed. For example, with reference to the example given earlier in FIG. 4B, a refractive element can be used for both beam deflector 12 and beam combiner 40. In order to be provided with beam-pointing correction, a refractive light deflector would have its equivalent refracting planes conjugated by beam-pointing correction apparatus 100 optics. As yet another alternative for deflecting light, a diffractive deflector could also be used. Such an embodiment may have mechanical advantages, since it can be comparatively easier to balance a grating or similar diffractive deflector that rotates about an axis that is normal to incoming light than to balance a rotating prism or tilted mirror. With such a diffractive device, the effective deflecting planes would be optically conjugated by beam-pointing correction apparatus 100 optics.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, the laser source itself could be an excimer laser or some other type of high frequency source. Laser 16 could be a pulsed solid-state laser, such as a frequency quadrupled YAG (Yttrium aluminum garnet) laser that is Q-switched or mode-locked. There are a number of options for providing beam deflector 12 as beam-deflecting element and its synchronously rotating beam combiner 40 as beam-recombining element for cyclic redirection and recombination of the pulsed radiation beam as used in the apparatus of the present invention. These include, for example, reflective rotating polygons, rotating monogons, or other type of rotatable reflective element.

Thus, what is provided is an apparatus and method for obtaining a pulsed light output with variable power, pulse-to-pulse, and including passive optical compensation for beam-pointing artifacts.

1. An apparatus for providing a modulated pulsed radiation beam, comprising:
a) a radiation source for providing a pulsed radiation beam at a constant pulse repetition frequency;
b) a plurality of beam intensity modulators;
c) a beam-deflecting element in the path of the pulsed radiation beam and rotatable about an axis to redirect the pulsed radiation beam cyclically towards each of the plurality of beam intensity modulators in turn;
d) a beam-recombining element rotatable about the axis in synchronization with the beam-deflecting element and disposed to combine modulated light from each of the plurality of beam intensity modulators in order to form the modulated pulsed radiation beam at the constant pulse repetition frequency;
and
e) at least one beam-pointing correction apparatus that optically conjugates the beam-deflecting element and the beam recombining element at least one rotational position about the axis.

2. The apparatus of claim 1 wherein the beam-deflecting element is actuable to redirect the pulsed radiation beam, a single pulse at a time, towards one of each of the plurality of beam intensity modulators in turn.

3. The apparatus of claim 1 wherein at least one beam intensity modulator is taken from the group consisting of a shutter, a piezoelectric actuated device, a voice-coil actuated device, a servo-actuated device, and a galvanometer-actuated device.

4. The apparatus of claim 1 wherein the at least one beam-pointing correction apparatus has the optical configuration of a 1× telescope.

5. The apparatus of claim 1 wherein the beam-deflecting element is a rotating monogon.

6. The apparatus of claim 1 wherein the radiation source is taken from the group consisting of an excimer laser and a pulsed solid-state laser.

7. The apparatus of claim 1 wherein at least one beam intensity modulator comprises a dichroic surface.

8. The apparatus of claim 1 wherein the beam intensity modulators are disposed at equal angular increments about the axis of rotation of the beam-deflecting element.

9. The apparatus of claim 1 wherein the beam-deflecting element deflects the incident pulsed radiation beam at an angle of less than 45 degrees.

10. The apparatus of claim 1 wherein the beam-deflecting element and beam-recombining element are coupled by a rotatable shaft.

11. The apparatus of claim 1 wherein the at least one beam-pointing correction apparatus comprises two or more lens elements.

12. The apparatus of claim 1 wherein the at least one beam-pointing correction apparatus comprises two or more curved reflective surfaces.

13. The apparatus of claim 1 wherein the beam-deflecting element is reflective.

14. The apparatus of claim 1 wherein the beam-deflecting element is refractive.

15. The apparatus of claim 1 wherein the beam-deflecting element is diffractive.

16. An apparatus for providing a modulated pulsed radiation beam, comprising:
a) a radiation source providing a pulsed radiation beam at a constant pulse repetition frequency;
b) a beam deflector on a rotatable shaft in the path of the pulsed radiation beam and actuable to cyclically redirect the pulsed radiation beam toward one of a plurality of beam intensity modulation channels at a time;
wherein the beam intensity modulation channels are disposed at equal angular increments about the axis of rotation of the rotatable shaft; and
c) a beam recombiner on the rotatable shaft for combining modulated light from each of the plurality of beam intensity modulators to form the modulated pulsed radiation beam at the constant pulse repetition frequency,
wherein at least one beam intensity modulation channel comprises:
(i) a beam intensity modulator for providing a variable attenuation of incident pulsed radiation; and
(ii) a beam-pointing correction apparatus that optically conjugates the beam deflector and beam recombiner for light directed to the beam intensity modulator.

17. A method for providing a modulated pulsed radiation beam, comprising:
a) providing a pulsed radiation beam at a constant pulsed repetition frequency;
b) redirecting the pulsed radiation beam cyclically, by deflection from a first beam-deflecting element, towards each of a plurality of beam intensity modulators, in turn, to form a modulated light;
c) combining the modulated light from each of the plurality of beam intensity modulators, by deflection from a second beam-deflecting element, in order to form the modulated pulsed radiation beam at the constant pulsed repetition frequency;
and
d) imaging the first beam-deflecting element to the second beam-deflecting element for light modulated by at least one of the plurality of beam intensity modulators.

18. The method of claim 19 wherein redirecting the pulsed radiation beam cyclically redirects, to each beam intensity modulator, a single pulse of the pulsed radiation beam at a time.

19. The method of claim 19 wherein imaging the first beam-deflecting element to the second beam-deflecting element comprises directing light through two or more lenses.

20. The method of claim 19 wherein imaging the first beam-deflecting element to the second beam-deflecting element comprises directing light to two or more concave reflective surfaces.
